(19) United States
(12) Patent Application Publication
(10) Pub. No.: US 2015/0064034 A1
(43) Pub. Date: Mar. 5, 2015

(54) MODULAR INTAKE FILTER SYSTEM, APPARATUS AND METHOD

(71) Applicant: Summit ESP, LLC, Tulsa, OK (US)

(72) Inventors: Gregory Austin Davis, Broken Arrow, OK (US); Joseph Stewart, Stillwater, OK (US)

(73) Assignee: Summit ESP, LLC

(21) Appl. No.: 14/469,353

(22) Filed: Aug. 26, 2014

Related U.S. Application Data
(60) Provisional application No. 61/870,635, filed on Aug. 27, 2013.

(51) Int. Cl. F04D 29/70; F04D 1/06; F04D 13/10; B01D 35/02; E21B 21/00; F04D 7/04

(52) U.S. Cl. CPC F04D 29/708; E21B 21/00; F04D 7/045; F04D 13/10; B01D 35/02; F04D 1/06
USPC 417/423.9; 210/416.1; 210/323.1; 137/549; 29/428

(57) ABSTRACT

A modular intake filter system, apparatus and method for an artificial lift pump assembly is described. A modular intake filter apparatus comprises at least one modular intake filter comprising a perforated housing supportively engaged to a production pump of an artificial lift assembly, and a porous media cartridge sealed to an exterior of the perforated housing, wherein a porosity of the porous media cartridge is selected to prevent media of a chosen size from entering the production pump, and wherein a number of the at least one modular intake filter in the apparatus is determined by calculating an area of filtration material required by dividing a selected flow rate of pumped fluid by a permeability of the porous media cartridge, and calculating the number of the at least one modular intake filters by dividing the area of filtration material required by a surface area of a single modular intake filter.

### CROSS REFERENCE TO RELATED APPLICATIONS

This application claims the benefit of U.S. Provisional Application No. 61/870,635 to Davis, filed Aug. 27, 2013 and entitled “MODULAR INTAKE FILTER SYSTEM, APPARATUS AND METHOD,” which is hereby incorporated by reference in its entirety.

### BACKGROUND OF THE INVENTION

1. Field of the Invention

Embodiments of the invention described herein pertain to the field of artificial lift pumping systems. More particularly, but not by way of limitation, one or more embodiments of the invention enable a modular intake filter apparatus, system and method for artificial lift pump systems.

2. Description of the Related Art

Artificial lift pumping systems are found in virtually all production wells today. Artificial lift systems are used for pumping fluid from a well bore. Typically, the produced fluid is oil, water, natural gas or a mixture of those fluids. One type of artificial lift pump system for downhole applications is an electric submersible pump (ESP) assembly. A typical ESP assembly is illustrated in FIG. 27 and includes a conventional motor 1, a conventional seal section 2 downstream of the motor, a conventional intake section 3 downstream of the seal section 2, and a centrifugal pump 4 downstream of the conventional intake 3. The pump assembly components each have shafts running longitudinally through their centers. The motor operates through a power cable connected to the surface and causes the shafts to rotate. Well fluid enters the centrifugal pump through the conventional intake section 3 and is lifted by the stages of centrifugal pump 4.

Other artificial lift pumping systems include rod pumps (beam lift), progressive cavity pumps, hydraulic pumps and jet pumps. Rod pumps, for example, are long slender cylinders inserted inside the tubing of a well. Rod pumps gather fluid from beneath the pump and lift them to the surface. Typically, rod pumps include a barrel, valves, piston and fittings. As the beam pumping system rocks back and forth, this operates the rod string, sucker rod and sucker rod pump, which work similarly to pistons inside a cylinder. The sucker rod pump lifts the oil, water and/or natural gas from the reservoir through the well to the surface.

Recently, a method of natural gas extraction known as hydraulic fracturing (“Facing”) has become economically important. Fracing makes use of artificial lift pumping systems. One challenge to economic and efficient artificial lift operation is pumping fluid containing sand, dirt, rock and other solid contaminants (“media”). Wells, which can be up to 12,000 feet deep in the ground, are commonly contaminated with media. Artificial lift pumping systems have tight clearances and/or high rotational speeds, and are therefore greatly impacted by media in the fluid—the pumps are susceptible to abrasive and erosive wear, and are also subject to problems such as pump starvation (insufficient flow), and cavitation, which is damage to pump components from bubbles created by vortexes in the well fluid. In recent years, some effort has been made to utilize flexible screens to filter large solids out of the well fluid in artificial lift pumping applications, but these screens suffer from drawbacks that fail to protect pumps from mechanical damage, abrasive and erosive wear from media, pump starvation and cavitation. Further, traditional screen designs are not easily customizable for an array of well environments having a variety of types and sizes of media in the well fluid.

Currently, many artificial lift designs combat media by using intake screens that contain large slots or perforations that block media from passing through the screen. In some instances, media is trapped and retained in the screen. These intake screens are limited in surface area, and over time, trapped contaminants may eventually clog the slots or perforations in the screen, thereby reducing inflow performance or starving the pump for fluid. Starving the pump can potentially cause pump failure due to the loss of mechanical lubrication in the pump by the absence of well fluid. In addition, if an ESP pump is starved for fluid, the loss of cooling well fluid passing by the motor can cause pump failure due to excessive heat produced by the electrical motor. Alternatively, the slots or perforations in the intake screen may be too large to contain much of the abrasives. For example, the slot or perforation may be a quarter of an inch in diameter, but the media may be only a micrometer in diameter and easily pass through the slots or perforations in the screen. If abrasives are not caught in the screen, they enter the pump and cause damage.

With respect to ESP pumps, there are typically two classes of traditional intake sections currently in use: bolted-on intakes and integral intakes. Bolted-on intake sections are usually bolted to an upper tandem or middle tandem pump, connecting the seal section to the pump, and contain a flexible screen with holes or slots. Typical intake screen perforations or slots may be between about ¼inch and 5/16 of an inch in diameter. FIG. 1A illustrates an example of a traditional bolted-on intake with a slotted screen of the prior art. FIG. 1B illustrates an example of a traditional bolted-on intake with a perforated screen of the prior art. These types of intake screens are prone to clogging, and are not typically effective at filtering smaller media.

Integral intakes, on the other hand, are usually used on lower tandem pumps and on lower tandem gas separators. The term “integral” denotes that the intake is part of the component assembly or finished product. In integral intakes, the intake functions as both the pump or gas separator base and pump intake. Integral intake sections are typically made from a single piece of metal for the body. FIG. 2A illustrates an example of an integral intake section on a pump base of the prior art. FIG. 2B illustrates an example of an integral intake section of the prior art on a gas separator. Intake ports of integral intakes, such as those shown in FIG. 2A and FIG. 2B, are not well suited to filter media from well fluid because they have large intake ports without any mechanism to filter out abrasive particles.

Thus, solids ingested into artificial lift pumping systems create a large amount of potential problems. It would be an advantage for pump intake sections, such as ESP intakes and rod pump intakes, to prevent a greater percentage of foreign solids from being ingested into the pump during operation, over a longer period of time than typical screens, without starving the pump or degrading inflow performance. It would also be an advantage to easily configure a pump with a media filter of sufficient surface area to better protect the pump from contaminants and plugging. Therefore, there is a need for a modular intake filter system, apparatus and method for artificial lift pumping applications.

### BRIEF SUMMARY OF THE INVENTION

A modular intake filter system, apparatus and method for artificial lift pumping applications is described. An illustrative embodiment of an electric submersible pumping system comprising a modular intake filter for screening media from well fluid comprises an electric submersible pump (“ESP”) assembly comprising an intake shaft that transfers horsepower from a seal section to a centrifugal pump of the ESP assembly, and an intake section secured between the seal section and the centrifugal pump by a head on a downstream side and a base on an upstream side, the intake section comprising at least two modular intake filters comprising a perforated housing, each modular intake filter threadedly engaged to an adjacent modular intake filter by a guide, and a porous media cartridge sealed to an exterior of the perforated housing, wherein a porosity of the porous media cartridge is selected to prevent media of a chosen size from entering the centrifugal pump. In some embodiments, a number of the at least two modular intake filters is determined by calculating an area of filtration material required by dividing a selected flow rate of pumped fluid by a permeability of the porous media cartridge, and calculating the number of the at least two modular intake filters by dividing the area of filtration material required by a surface area of a single modular intake filter. In some embodiments, the system comprises a radial support bearing comprising a rotatable sleeve keyed to the intake shaft and a stationary bushing pressed into the guide. In certain embodiments, the system further comprising at least three radial support bearings, wherein one of the at least three radial support bearings is located in each of the head, guide and base. In some embodiments, the system further comprises a screen surrounding the exterior of the porous media cartridge. In certain embodiments the porous media cartridge comprises a media grade of between 0.1 and 100. In further embodiments, there are between two and forty modular intake filters.

An illustrative embodiment of a modular intake filter apparatus for an artificial lift pumping system comprises at least one modular intake filter comprising a perforated housing supportively engaged to a production pump of an artificial lift assembly, and a porous media cartridge sealed to an exterior of the perforated housing, wherein a porosity of the porous media cartridge is selected to prevent media of a chosen size from entering the production pump, and wherein a number of the at least one modular intake filter in the apparatus is determined by calculating an area of filtration material required by dividing a selected flow rate of pumped fluid by a permeability of the porous media cartridge, and calculating the number of the at least one modular intake filters by dividing the area of filtration material required by a surface area of a single modular intake filter. In some embodiments, the threaded perforated housing is threaded to the production pump by a head, wherein the head further comprises a spider bearing pressed into the head and a stationary bushing of a hydraulic bearing set pressedly coupled to the spider bearing. In certain embodiments the production pump is a multistage centrifugal pump. In other embodiments, the production pump is a rod pump. In certain embodiments, the viscosity of the pumped fluid is about 1.0 centipoise and the selected flow rate is about 116.6 gallons per minute.

An illustrative embodiment of a method of filtering media from a fluid entering an artificial lift pump system, the method comprises selecting a porosity for a media cartridge to use in a modular intake filter for an artificial lift pumping application, installing a media cartridge of the selected porosity on a perforated housing to form the modular intake filter, and a step for computing a number of modular intake filters required to maintain a selected flow rate, the computation comprising at least the factors of a surface area of one of the modular intake filter, the selected flow rate of pumped fluid, and a permeability of the media cartridge of the selected porosity. In some embodiments the method further comprises joining in series the required number of modular intake filters as computed. In certain embodiments, the required number of modular intake filters are joined by threading in series with a guide. In some embodiments, the step for computing the number of modular intake filters comprises rounding based on the magnitude of modules. In some embodiments, the step for computing the number of modular intake filters needed is comprises rounding based on proximity to a nearest whole number of modules.

In further embodiments, features from specific embodiments may be combined with features from other embodiments. For example, features from one embodiment may be combined with features from any of the other embodiments. In further embodiments, additional features may be added to the specific embodiments described herein.

### BRIEF DESCRIPTION OF THE DRAWINGS

The above and other aspects, features and advantages of the invention will be more apparent from the following more particular description thereof, presented in conjunction with the following drawings wherein:

FIG. 1A illustrates an example of a traditional bolted-on intake with a slotted screen of the prior art.

FIG. 1B illustrates an example of a traditional bolted-on intake with a perforated screen of the prior art.

FIG. 2A illustrates an example of an integral intake of the prior art on a pump base.

FIG. 2B illustrates an example of an integral intake of the prior art on a gas separator.

FIG. 3 is an elevation view of an ESP pump assembly making use of a modular intake filter of an illustrative embodiment.

FIG. 4 is a perspective view of a single modular intake filter of an illustrative embodiment with an outer layer broken away.

FIG. 5 is a cross sectional view taken across line 5-5 of FIG. 4 of an illustrative embodiment of a modular intake filter.

FIG. 6 is an enlarged view of one embodiment of a modular intake filter.

FIG. 7 is a perspective view of a modular intake section of an illustrative embodiment for an ESP assembly.

FIG. 8 is an elevation view of a modular intake section of an illustrative embodiment.

FIG. 9 is a cross sectional view taken along line 9-9 of FIG. 8 of a modular intake section of an illustrative embodiment.

FIG. 10 is a cross sectional view taken along line 10-10 of FIG. 8 of a guide of an illustrative embodiment.

FIG. 11 is a cross sectional view taken along line 11-11 of FIG. 8 of a modular intake filter of an illustrative embodiment.

FIG. 12 is a perspective view of an illustrative embodiment of a modular intake section having three modules.

FIG. 13 is a perspective view of an illustrative embodiment of a modular intake section having four modules.

FIG. 14 is a perspective view of an illustrative embodiment of a modular intake filter with outer layers broken away.

FIG. 15 is a cross sectional view taken across line 15-15 of FIG. 14 of an illustrative embodiment of a modular intake filter.

FIG. 16 is an enlarged view of a modular intake filter.

FIG. 17 is a perspective view of a base of an illustrative embodiment

FIG. 18 is a perspective view of a head of an illustrative embodiment.

FIG. 19 is a perspective view of a guide of an illustrative embodiment.

FIG. 20 is a perspective view of a modular intake section of an illustrative embodiment for a rod pump assembly.

FIG. 21 is a top view of a modular intake section of an illustrative embodiment for a rod pump assembly.

FIG. 22 is a cross sectional view taken across line 22-22 of an illustrative embodiment of a rod pump modular intake section.

FIG. 23 is an enlarged macroscopic view of a porous media cartridge of an illustrative embodiment.

FIG. 24 is an enlarged microscopic view of a porous media cartridge of an illustrative embodiment.

FIG. 25 is a flow chart of an illustrative embodiment of a method of installing a modular intake filter into an ESP assembly.

FIG. 26 is an elevation view of a rod pump assembly having a modular intake section of an illustrative embodiment.

FIG. 27 is a conventional ESP assembly of the prior art.

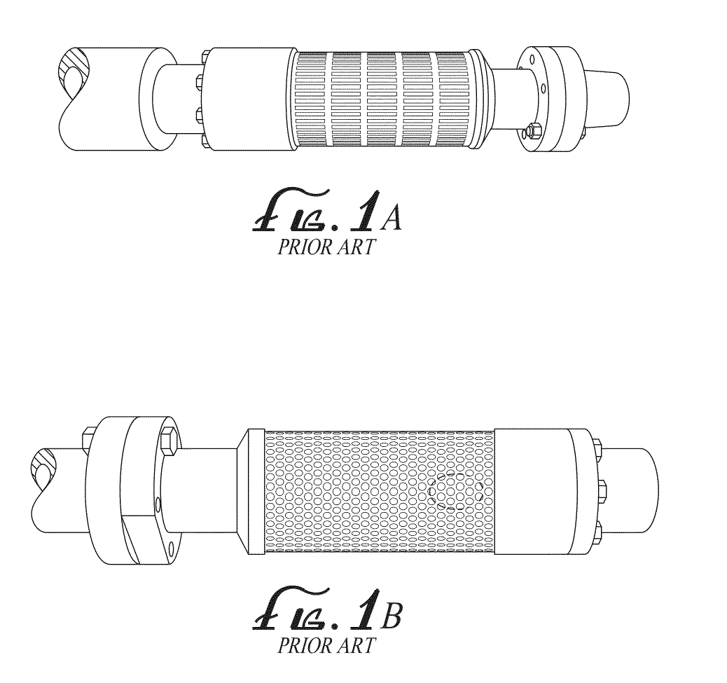

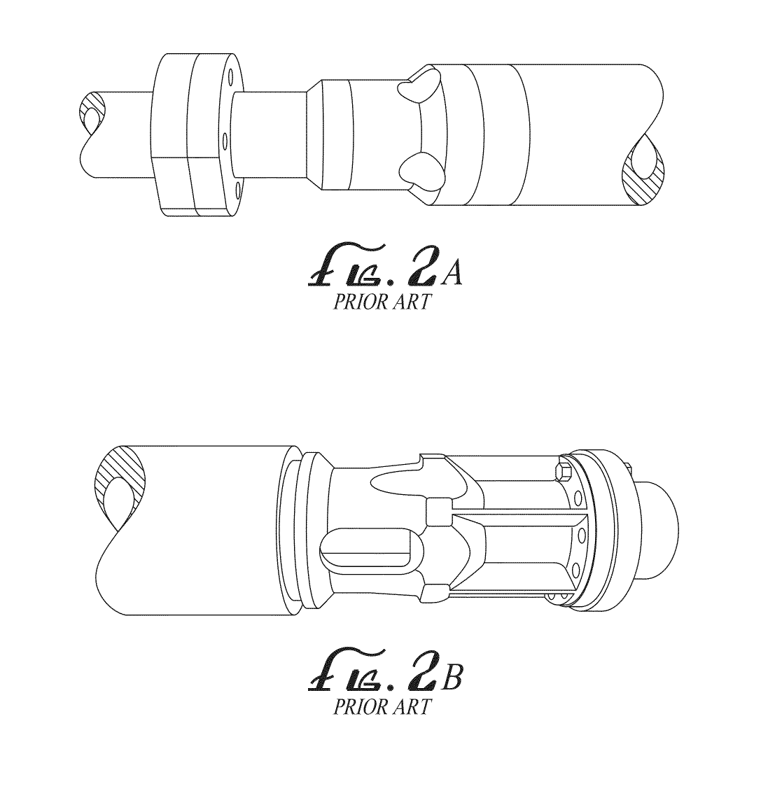

While the invention is susceptible to various modifications and alternative forms, specific embodiments thereof are shown by way of example in the drawings and may herein be described in detail. The drawings may not be to scale. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION

A modular intake filter system, apparatus and method will now be described. In the following exemplary description, numerous specific details are set forth in order to provide a more thorough understanding of embodiments of the invention. It will be apparent, however, to an artisan of ordinary skill that the present invention may be practiced without incorporating all aspects of the specific details described herein. In other instances, specific features, quantities, or measurements well known to those of ordinary skill in the art have not been described in detail so as not to obscure the invention. Readers should note that although examples of the invention are set forth herein, the claims, and the full scope of any equivalents, are what define the metes and bounds of the invention.

As used in this specification and the appended claims, the singular forms “a”, “an” and “the” include plural referents unless the context clearly dictates otherwise. Thus, for example, reference to a modular intake filter may also refer to multiple modular intake filters.

As used in this specification and the appended claims, the terms “media”, “solids”, “laden well fluid,” “foreign solids” and “contaminants” refer to sand, rocks, rock particles, soils, slurries, and any other non-liquid, non-gaseous matter found in the fluid being pumped by an artificial lift pumping system.

As used in this specification and the appended claims, the term “perforated housing” refers to a perforated or slotted supportive, skeleton-like structure for an intake section that, together with the head, guide(s) and/or base, holds and aligns the intake section in the pump assembly.

As used in this specification and the appended claims, the terms “modular” and “module” refer to largely identical components of similar size, construction and porosity that may be connected to one another by engagement in a series, such as threaded and/or bolted engagement. In an electric submersible pump (ESP) assembly, one or more modules may be placed between the centrifugal pump and/or gas separator on one hand, and the seal and/or motor on the other hand. In a rod pump assembly, one or more modules may be placed between the gas separator and rod pump.

As used in this specification and the appended claims, the term “guide” describes a coupling between two intake modules that allows one module to be threadedly engaged with another module. In some embodiments, a “guide” may be similar to guides conventionally employed in seal sections of ESP assemblies.

As used in this specification and the appended claims, the term “permeability” with respect to a porous media cartridge is a measure of the ability of a fluid to flow through the porous media cartridge, expressed as a rate per area. A porous media cartridge's permeability is a measured characteristic of the material that depends upon the viscosity and state of matter of the fluid flowing through the porous media cartridge, the pressure drop of the fluid flowing through the material and the thickness of the porous media cartridge.

Illustrative embodiments may improve a pump assembly's handling of solids in well fluid. A porous media cartridge may be placed circumferentially about a supportive, perforated housing of a pump assembly's intake section. The porosity of the porous media cartridge may be selected based upon well conditions, such as the size, type and/or quantity of media mixing with well fluid, and assist in controlling a maximum size of media allowed to pass into the pump. The intake section may be modularized to maintain a desired flow rate regardless of the chosen porosity of the porous media cartridge. The presence of multiple filter modules may increase the run life of the pump by increasing the time to plugging of the intake, as a result of the substantially increased surface area of the intake of illustrative embodiments. Multiple modules may be threadedly engaged to one another using guides. In some embodiments, a slotted or perforated screen may be wrapped about the outside of the porous media.

Illustrative embodiments may prevent a majority of solids larger than a selected size from entering a pump, such as a centrifugal pump or a rod pump, during operation. The modular intake filter system of illustrative embodiments improves over traditional intake sections and traditional intake screens by operating over a longer period of time without starving (shutting off) the inflow performance of the pump. The invention may extend the run life of the artificial lift pump system by preventing smaller media from entering the pump system than would otherwise be possible with traditional intake filters, since the porous media cartridge may filter much smaller particles than conventional screens. Further, the invention may provide for an intake section that is customizable to individual well environments and resistant to clogging due to an increased surface area.

Illustrative embodiments may lower the cost of the pumping equipment (such as ESP pumping equipment) while increasing production by extending pump run life. Pumps utilizing the invention may not require internal coating of the equipment (such as tungsten carbide coating to harden surfaces of pump components), the use of extensive abrasive resistant technology, or other abrasive combative equipment, such as a “sand seal.” Illustrative embodiments may keep solids and other media from entering or accumulating on the top of the seal section of ESP assemblies by preventing media from being taken into the pump in the first place.

While adding numerous modular intake filters of illustrative embodiments to artificial lift assemblies may increase the initial cost of the pump, the modular intake filter reduces overall costs from a long term perspective by better protecting the pump from solids and other media and hence increasing the run life. Further, the increased surface area of the filter provided by illustrative embodiments may increase flow and reduce the potential for plugging and the time between plugging. In addition, the modularity of the intake filters of illustrative embodiments, allows an intake section to be easily customized for a particular well environment, such as based on the composition of the well fluid, and the size of abrasive media present therein.

One or more embodiments of the invention provide a modular intake filter system, apparatus and method, for use in artificial lift pumping applications, such as ESP applications and rod pump applications. While for ease of illustration, illustrative embodiments are primarily described in terms of an ESP application for pumping oil, water and/or gas, nothing herein is intended to limit the invention to those embodiments. Illustrative embodiment may be similarly employed in rod pump assemblies, progressive cavity pumps, hydraulic pumps, and jet pump assemblies.

Pump Assembly

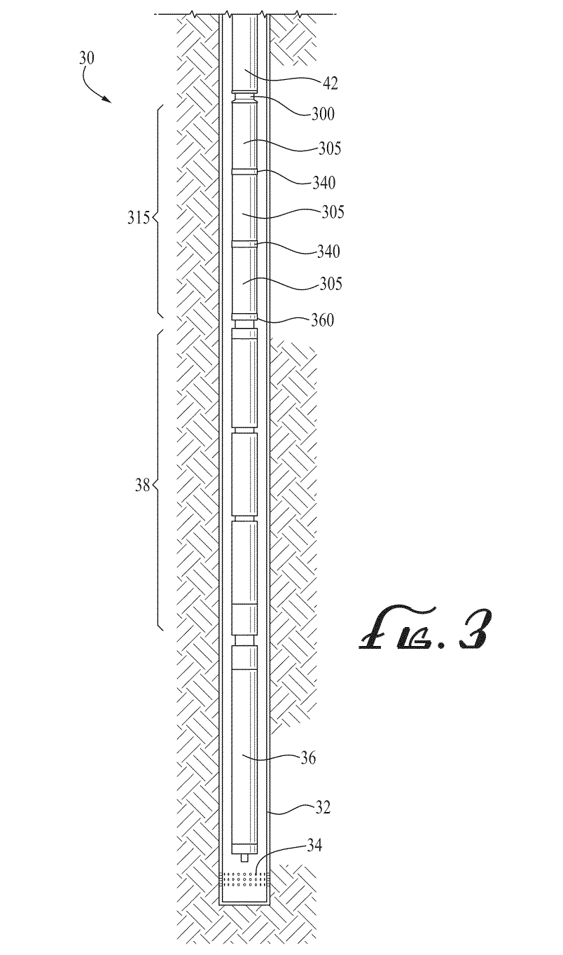

The modular intake filter of illustrative embodiments may be placed in an artificial lift pump assembly in place of, or in addition to, the conventional intake section. An illustrative embodiment of ESP pump assembly making use of a modular intake section of an illustrative embodiment is shown in FIG. 3. As shown in FIG. 3, ESP assembly 30 is located beneath the ground inside casing 32. Perforations 34 in casing 32 allow well fluid to enter casing 32 and be lifted by ESP assembly 30. Motor 36 may be an electric motor such as a three-phase, two-pole squirrel cage induction motor, permanent magnet motor or a wound type motor. Motor 36 may obtain power through a power cable (not shown) connected to a power source at the surface of the well. Motor 36 turns a motor shaft, which extends longitudinally through the center of motor 36. In order to function properly, electrical motor 36 must be protected from well fluid ingress, and seal section 38 provides a fluid barrier between the well fluid and motor oil. Motor oil resides within seal section 38, which is kept separated from the well fluid. In addition, seal section 38 supplies oil to electrical motor 36, provides pressure equalization to counteract expansion of motor oil in the well bore and carries the thrust of centrifugal pump 42. The seal section has a shaft that is connected to the motor shaft, for example by splining, such that the seal section shaft rotates with the motor's shaft.

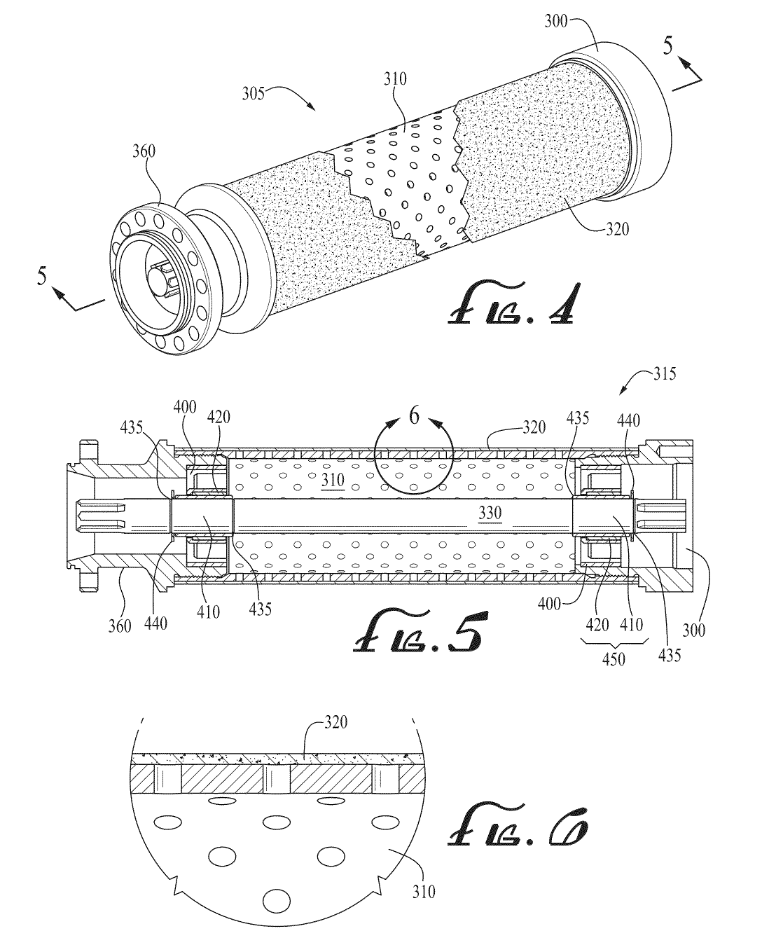

As shown in FIG. 3, seal section 38 is bolted to intake section 315, intake section 315 being downstream of seal section 38. Intake section 315 may be bolted and/or threaded to seal section 38 with base 360. Intake section 315 includes an intake shaft 330 (shown in FIG. 5) extending longitudinally through its center. The intake shaft 330 is coupled, for example splined, to the seal section shaft on one side and the centrifugal pump shaft on the other side, such that all the shafts rotate together during operation of electric motor 36. As illustrated in FIG. 3, three modular intake filters 305 are included in intake section 315. One or more modular intake filters 305 may be used in illustrative embodiments. The three modular intake filters 305 shown in FIG. 3 are threaded to one another by two guides 340. Head 300 secures intake section 315 to centrifugal pump 42. Well fluid enters centrifugal pump 42 through intake section 315. Centrifugal pump 42 may be a multistage centrifugal pump and lift fluid through production tubing (not shown) to the surface of the well.

Modular Intake Filter Components

An intake section of an artificial lift assembly of illustrative embodiments includes one or more modular intake filters. FIGS. 4-6 illustrate a modular intake filter 305 of an illustrative embodiment. Various embodiments of modular intake filter 305 may include perforated housing 310 and porous media cartridge 320. Perforated housing 310 may be stainless steel, 9-chrome, or another strong, corrosion resistant material. Unlike a traditional screen, perforated housing 310 may be a tubularly shaped, solid piece of metal that acts as a supportive skeleton for porous media cartridge 320. The perforated housing includes holes, slots, ports or perforations (perforations) that allow for entrance of fluid into the pump, and with respect to multistage pumps, direct the fluid into the first stage of the pump. The perforations in the perforated housing may not substantially contribute to the filtration of solids in well fluid. Instead, porous media cartridge 320, which wraps around the perforated housing like skin, may carry the primary filtration function.

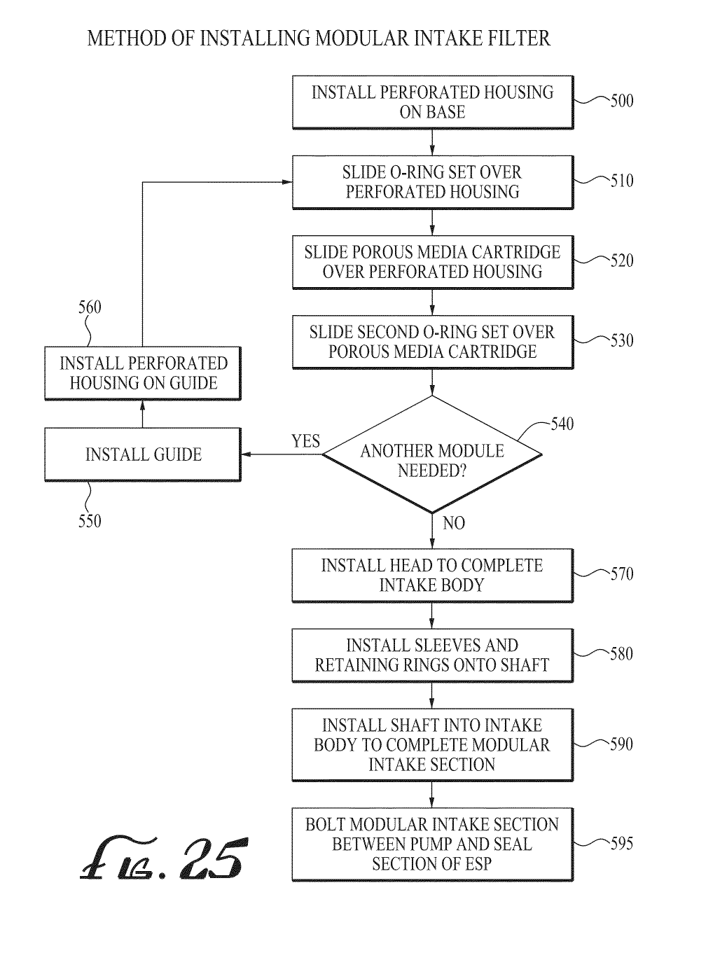

Modular intake filter 305 may vary in porosity depending on the size of the pores (porosity or media grade) selected for porous media cartridge 320. Illustrative embodiments of porous media cartridge 320 are shown in FIGS. 23 and 24. FIG. 23 illustrates a macroscopic view of a porous media cartridge having a media grade of 40. FIG. 24 illustrates a microscopic view of a porous media cartridge 320 having a media grade of 40. In some embodiments, the slots or perforations of perforated housing 310 and/or screen 1400 (shown in FIG. 14) may not affect the porosity of modular intake filter 305 since porous media cartridge 320 may prevent passage of significantly smaller media than perforated housing 310. For example, porous media cartridge 320 may prevent passage of media on the order of microns in diameter (for example, 40 microns or larger in the case of a media grade of 40), rather than on the order of inches in diameter as would a traditional screen. In certain embodiments, the combination of the size of the openings of perforated housing 310 and the porosity of porous media cartridge 320 may determine the porosity of modular intake filter 305. In other embodiments, the combination of the size of openings of perforated housing 310, the porosity of porous media cartridge 320 and the slots or perforations in an outer screen 1400 may determine the porosity of modular intake filter 305.

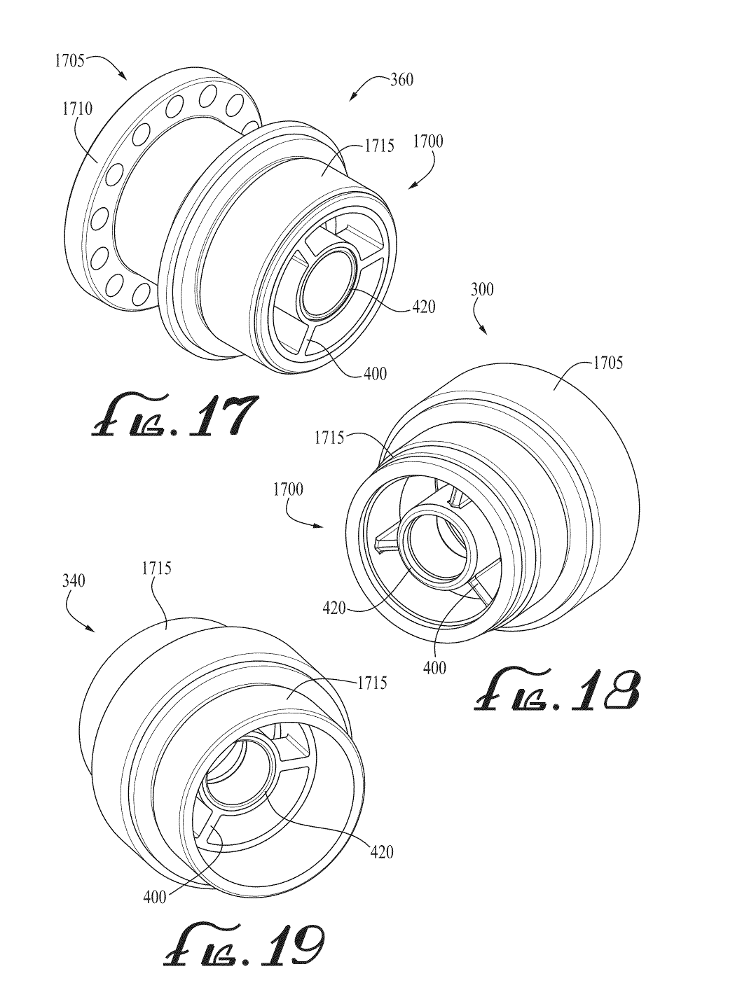

Porous media cartridge 320 may be a sintered, porous metal, isometric and tubular in shape, which surrounds the outer surface of perforated housing 310. In other embodiments, porous media cartridge 320 may be a fiberglass weave or any corrosion resistant, porous material consistent with a selected media grade. Porous media cartridge 320 may be located outside perforated housing 310, for example porous media cartridge 320 may circumferentially surround perforated housing 310 so as to provide a filtration layer with a desired porosity. Porous media cartridge 320 may entirely enclose perforated housing 310 in a tubular fashion, and may be sealed, such that fluid passing into the pump must first pass through porous media cartridge 320 prior to entering a pump of an artificial lift assembly. Porous media cartridge 320 and/or a screen 1400 (shown in FIG. 15) may be installed on intake section 315 such that the outer diameter of the pump assembly remains uniform.

Different porosity, and hence control over the maximum allowable particle size that can be admitted inside the pump, may be achieved by using different materials or different media grades for porous media cartridge 320. In some embodiments, porous media filter 320 may be “316 Stainless Porous metal,” which is available in various porosity sizes (various media grades). Mott Corporation of Farmington, Conn. supplies suitable porous metal. Using this metal for the media filter has several advantages. The 316 stainless steel is less prone to corrosion, it is strong and it may not collapse under high differential pressure (plugging). Exemplary media grades are 0.1, 0.2, 0.5, 1, 2, 5, 10, 20, 40 and 100. In general, the media grade may be the mean micron rating of the porous metal or other porous material. For example, a media grade of “10” or “10.0” may prevent 90% of particles in a liquid stream having a 10.0 micrometer outer diameter or larger from passing through the cartridge. The percentage of media of a given size that may be prevented from passing through porous media cartridge 320 having a selected porosity may depend upon the porous material employed and/or the composition of the well fluid. For example, 90% of media having an outer diameter of 10.0 micrometers or greater may be prevented from passing through porous media cartridge 320 of media grade 10 in a liquid stream, but 99.9% of that sized media may be prevented from passing through porous media cartridge 320 of media grade 10 in a gas stream. In some embodiments, a material for use as porous media cartridge 320 may include a stainless steel metal cylinder having a selected porosity size. In some embodiments, the porosity of porous media cartridge 320 may be selected based on the type, quantity and/or size of media found in the well environment and/or fluid to be pumped.

In some embodiments, a traditional perforated or slotted flexible screen may be used around the outside of porous media cartridge 320. FIGS. 14-16 illustrate an embodiment of a modular intake filter 305 including perforated housing 310, porous media cartridge 320 and screen 1400. In such instances, the porous media cartridge 320 may be sandwiched and/or sealed between perforated housing 310 and the screen 1400. In instances where screen 1400 is employed, screen 1400 may be rolled, wrapped around the assembled module and welded along seam 1405. It may not be necessary to seal screen 1400 on the top and bottom sides, since screen 1400 includes large slots or perforations (on the order of inches) in any event.

Shaft 330 shown in FIGS. 5 and 15, provides the transfer of horsepower from seal section 38 to centrifugal pump 42 on an ESP assembly, for example. Shaft 330 may be splined on the ends. In such embodiments, the splines engage into couplings in the seal section shaft and pump shaft, which transfers shaft 330 movement and power from seal to pump.

Perforated housing 310 may include threading on the top and bottom sides of the tube in order to be threaded to a head 300, base 360 and/or guides 340. Modular intake filter 305 may be bolted and/or threadedly connected to a pump, seal section, motor and/or one or more other modular intake filter 305 of illustrative embodiments in one or more of four combinations—head 300 to base 360, head 300 to guide 340, guide 340 to guide 340, or guide 340 to base 360. Head 300 may be located at the downstream most side of intake section 315 and base 360 may be located at upstream most side of intake section 315.

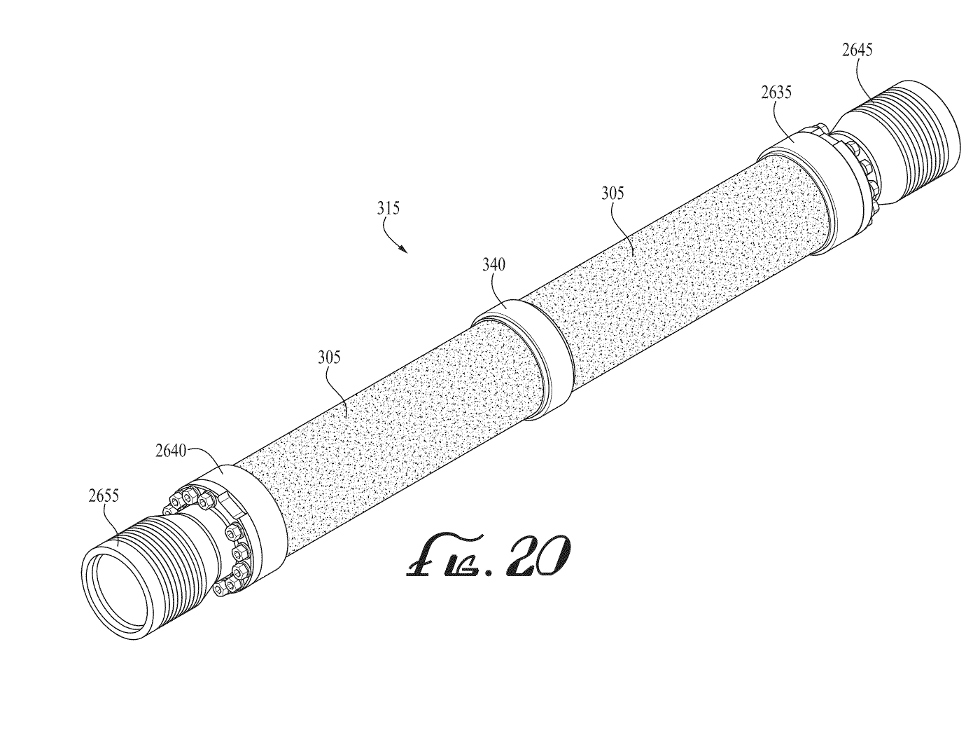

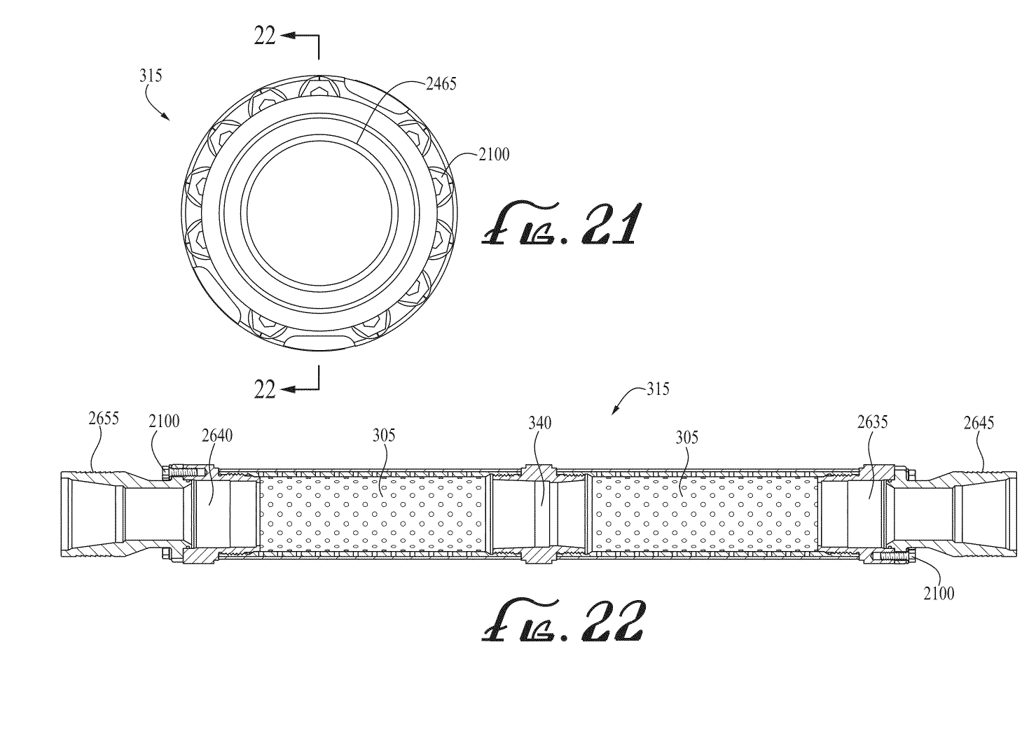

An illustrative embodiment of head 300 is shown in FIG. 18. An illustrative embodiment of base 360 is shown in FIG. 17. Head 300 and base 360 may each include two sides: one intake side 1700 to be secured to the adjacent perforated housing 310 of a filter module 305, and one component side 1705 to be secured to the adjacent artificial lift assembly component, for example a pump, gas separator or seal section. Head 300 and base 360 may be drilled and tapped to include threaded bolt holes on a neck and flange 1710. In this way, in an ESP embodiment for example, head 300 may be secured to the pump of the ESP assembly and base 360 may be secured to the seal section of the ESP assembly. In embodiments where intake section 315 is placed in a different location in an artificial lift assembly (somewhere other than between the pump and the seal section), then head 300 and base 360 provide for secure fastening to the pump components located immediately downstream and upstream of the pump intake 315 respectively. The intake side 1700 of head 300 and base 360 facing perforated housing 310 may include threads 1715 for threaded engagement to perforated housing 310 and/or modular intake filter 305. Guide 340 may comprise threads 1715 on both sides for threaded engagement to perforated housing 310 and/or modular intake filter 305. FIG. 19 is an illustrative embodiment of guide 340. In some embodiments, guide 340 may be similar to a guide located in a convention ESP seal section.

Radial Support Components

Head 300, base 360 and/or guide 340 of modular intake filter 305 may include a bearing set for radial support. Radial support becomes increasingly important as the length of intake section 315 increases. An intake section 315 that includes multiple modules may be significantly longer than traditional intake sections. For example, an intake section of an illustrative embodiment including 10 modules may be in excess of 13 feet long, as opposed to traditional intakes that are only one or two feet in length. FIG. 10 shows an illustrative embodiment of a supportive bearing set included in a guide 340. Bearing set 450 including bushing 420 and sleeve 410 may provide for radial support on shaft 330. Sleeve 410 may be keyed or otherwise attached to rotatable shaft 330 such that it rotates with shaft 330 inside stationary bushing 420. The rotation of sleeve 410 inside bushing 420 creates a radial support bearing during operation of the artificial lift assembly. As the length of intake section 315 is increased through the addition of modules, additional sleeve 410 and bushing 420 sets 450 may be added in head 300, base 360 and/or guide 340 for radial support.

Sleeve 410 may be keyed to shaft 330 and rotate at the same speed as shaft 330. Bushing 420 may be pressed into spider bearing 400 and/or the wall of head 300, base 360 and/or guide 340 and remain stationary during operation of the pump assembly. Spider bearing 400 may be pressed into head 300, base 360 and/or guide 340 where a bushing 420 is placed and may assist in securing bushing 420 such that it remains stationary during pump operation. During operation of the pump, a thin film of fluid may form in between rotating sleeve 410 and stationary bushing 420, providing hydrodynamic and/or hydraulic support.

Bushing 420 and/or sleeve 410 may be made of tungsten carbide or other suitable material at least as hard as the abrasive solids found in the laden well fluids, for example media smaller than the selected size to be filtered. For example, the bearing surface may be tungsten carbide, silicon carbide, titanium carbide, or other materials having similar properties. Ceramic as well as other manmade compounds, or steel alloys having special surface coatings to increase surface hardness may also be used. Examples of suitable coatings may include nickel boride, plasma type coatings or surface plating like chrome or nickel. Diffusion alloy type coatings may also be suitable. In some embodiments, a sufficient amount of media is filtered from the well fluid by modular intake filter 305 such that a hard material or coating is not necessary for bearing set 450. As additional modules 305 are added to intake section 315 and the length of section 315 increases, additional bearing sets of bushing 420 and sleeve 410 may be included in the head 300, base 360 and guides 340 of the section 315 in order to provide support and reduce the risk of buckling.

Intake Section Modules

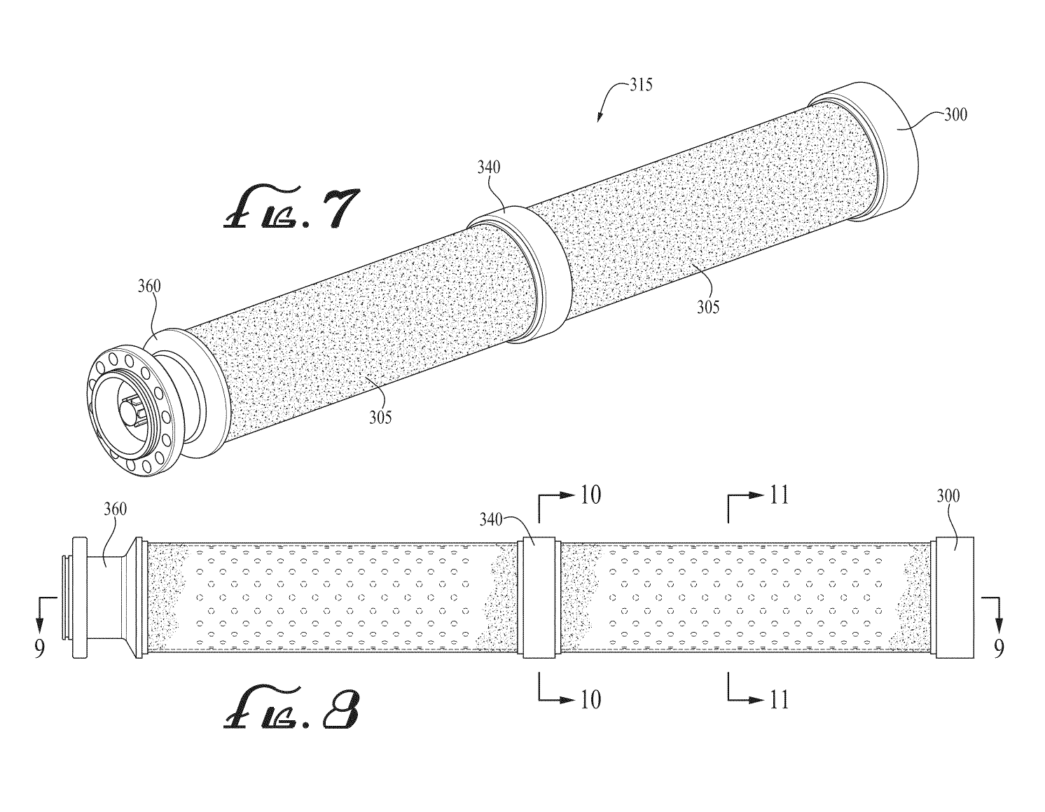

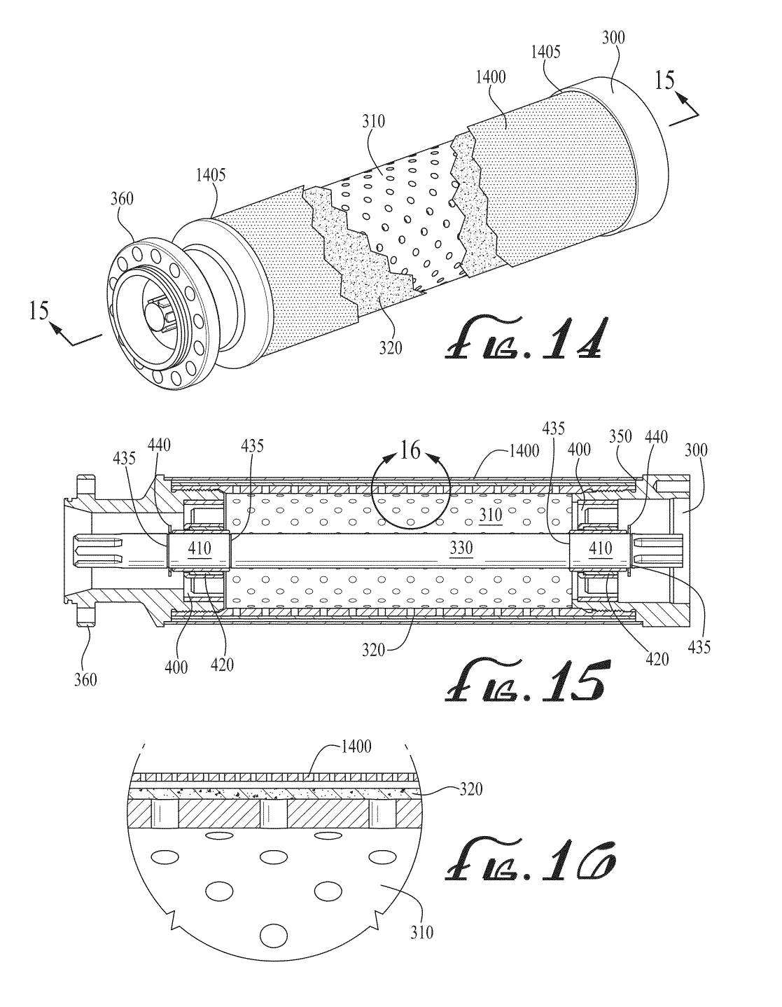

Intake section 315 may comprise one or more modules. One or more modular intake filter 305 may be joined together to create intake section 315. A first modular intake filter 305 may be threadedly joined to an adjacent modular intake filter 305 with guide 340. For example, an intake section including two modular intake filters 305 is shown in FIGS. 7-9. An intake section including three modular intake filters 305 is shown in FIG. 12, and an intake section 315 including four modular intake filters 305 is shown in FIG. 13. Embodiments including more than four modular intake filters 305, or only a single modular intake filter 305, are also contemplated, as described in detail herein. In some embodiments, intake section 315 having two modules, as shown in FIGS. 7-9, may comprise three bearing sets 450 for radial support: one in head 300, one in guide 340 and one in base 360. Similarly, embodiments of an intake section 315 having three modules 305, such as that shown in FIG. 12, may comprise four bearing sets 450: one set 450 in each of the head 300, base 360 and two guides 340. In yet further embodiments, an intake section 315 comprising a single module as for example shown in FIG. 5, may include two bearing sets, one in head 300 and one in base 360.

A desired porosity of porous media cartridge 320, and hence intake section 315, may be selected. For example, the selection may be based on the size, composition and/or quantity of media in the pumped fluid. Once a desired porosity of porous media cartridge 320 and/or intake section 315 is chosen, one would determine the number of modular intake filter 305 to install in intake section 315 based on the area of filtration material needed to maintain a desired flow rate and/or acceptable pressure drop. One could, for example, install a single modular intake filter 305, or one could install 20 modular intake filters. If one were to select a media size of, for example 20 microns as the maximum allowable particle size that may be admitted inside the pump, the required filter surface area would be much larger than a filter for solids of 100 microns as the maximum allowable particle size, if the desired flow rate is to be maintained. In particular, one may determine the number of modular intake filter 305 to be included in intake section 315 by considering desired flow rate, permeability of the porous media cartridge 320 of the chosen porosity (media grade), and the fixed surface area of a single modular intake filter 305.

Table 1 provides examples of how to compute the number of modular filters 305 required to maintain a flow rate, with a selected porosity of a porous media cartridge having a given permeability with respect to a fluid of known viscosity, where a single module has a surface area of 1.6057 ft² (e.g., a cylinder/tube having a height of 16 inches and a circumference of 4.6 inches). An exemplary calculation may proceed as follows:

First, select a media grade for porous media cartridge 320. The media grade may be selected based upon the maximum sized media that will be allowed to enter into pump intake 315. For example, if a porosity of “5” is selected, 90% of media in the well fluid having an outer diameter of 5.0 micrometers or larger may be prevented from passing through porous media cartridge 320. The porous media cartridge 320 having the selected media grade (porosity), employed in a fluid of a known viscosity, at a particular pressure drop, will have an associated permeability as a feature of the porous media cartridge 320. In this example, porous media cartridge 320 with a porosity of 5 has a liquid permeability of 6.8 gpm/ft² at a 1.0 psi pressure drop and a fluid viscosity of 1.0 centipoise. This information may be determined, for example, by flow curves of porous media cartridge 320.

Second, select the desired flow rate of the pump. The desired flow rate may depend upon the particulars of the pumping application such as the type of fluid being pumped, the composition of the fluid be pumped and/or the type of pump employed—for example an ESP pump or a rod pump. In this example, the desired flow rate is 116.6 gallons per minute (gpm).

Third, divide the desired flow rate by the permeability of the porous media cartridge 320 having the selected porosity, to determine the area of filtration material required at the selected porosity. This formula may be expressed as

$$A = \frac{{FR}_{Desired}}{P} ;$$

where A is the area of filtration material needed at the selected porosity, FR_{Desired} is the desired flow rate, and P is the permeability of porous media cartridge 320 at the selected porosity. Continuing with the example, if a porosity of 5 is selected and a desired flow rate of 116.6 gpm is chosen, then P is 6.8 gpm/ft² if the fluid is liquid, and A=17.147 ft².

Fourth, divide the area of filtration material needed by the surface area of a single modular intake filter 305 and/or the surface area of porous media cartridge 320 contained on a single filter module 305. The surface area of a single modular intake filter 305 and/or the surface area of filtration material sealed onto a single modular intake filter 305 may be fixed based upon the particular type of pump employed. In the example, a single module 305 has a surface area of 1.6057 ft². Thus, the number of modules needed may be calculated using the formula

$$M = \frac{A}{S} ;$$

where M is the number of modules needed, A is the area of filtration material needed, and S is the surface area of a single module 305. Continuing with the example, if a surface area (A) of 17.147 ft² of filtration material is needed, and the surface area of a single module 305 is 1.6057 ft², then 10.596 modules are needed in this example.

Fifth, round the number of modules to a whole number based on the selected rounding method. For example, it may be desired to round to the nearest whole number. In this case, 10.596 modules may be rounded up to eleven modular intake filters 305.

In the illustrative example, eleven modular intake filters may then be joined in series as described herein, for example threaded and/or bolted, to form intake section 315, and incorporated into an artificial lift pump assembly. Additional exemplary calculations to determine the number of modular intake filters 305 which may be employed in an intake section 315 are illustrated in Table 1.

TABLE 1
Modular Filter Quantity Calculations
Using 1.0 centipoise (cP) as the viscosity of the
well fluid and 116.6 gallons per minute (gpm) as the desired flow rate:

| Media Grade | | | |
|---|---|---|---|
| (porosity) | 10 | 5 | 1 |
| Permeability for | 12 gpm/ft² @ | 6.8 gpm/ft² @ | 1.8 gpm/ft² @ |
| a liquid fluid | 1 PSI drop | 1 PSI drop | 1 PSI drop |
| Area of filtration material required = | $\frac{116.6 gpm}{12 gpm \text{/} {ft}^{2}}$ | $\frac{116.6 gpm}{6.8 gpm \text{/} {ft}^{2}}$ | $\frac{116.6 gpm}{1.8 gpm \text{/} {ft}^{2}}$ |
| Square feet of | 9.71667 | 17.147 | 64.7 |
| filtration | | | |
| material needed | | | |
| at this media | | | |
| grade | | | |
| Modules needed | 6 modules | 11 modules | 40 modules |
| to maintain | | | |
| desired flow rate | | | |

As illustrated by the above calculations, the formula for determining the minimum number of modules required to maintain a desired flow rate may be also be expressed as

$$M = \frac{{FR}_{Desired}}{P * S} ;$$

where M is the number of modules required, FR_{Desired} is the desired flow rate, P is the permeability of the filtration material and S is the surface area of a single module 305.

The ability of the invention to allow the installation of porous media cartridge 320 of varying porosity is important to the application because doing so allows control of the maximum allowable particle size that may be admitted inside the pump. The modularity of intake section 315 allows one to maintain flow rates despite the porosity selected, which porosity may be selected from a wide range of possibilities as described herein, for example media grades ranging from 0.1 to 100. Over the run life of a pump system, all filters may eventually plug off, which may starve the pump for fluid and create a pressure differential in the pump. In the modular intake filter of the invention this problem may be combated by the presence of multiple filter modules.

The above exemplary calculations use 1.0 cP as the viscosity of the fluid to be pumped. The viscosity of the pumped fluid will depend on the composition and temperature of the fluid, with higher temperatures lowering the viscosity of the fluid. Water at 160° F. has a viscosity of approximately 0.4 cP. Oil mixed in with the water will increase the viscosity. In some embodiments, the viscosity of pumped fluid will between 1.0 cP and 10.0 cP, with most applications being on the lower end of that range.

The above exemplary calculations use 116.6 gpm as the desired flow rate. The desired flow rate may vary based upon the application and may be between 500 barrels of fluid per day (BPD) to 4,000 BPD, which would be between 14.583 gpm and 116.66 gpm.

The above exemplary calculations also use 1.6057 ft² as the fixed surface area of a single module 305. The surface area of a single module 305 may be fixed based upon the particular pump series design, for example a type “513 intake” or a type “400 intake”. The surface area of a single module 305 may also be fixed based upon the type of artificial lift system employed, such as an ESP assembly or a rod pump assembly.

Because the surface area of a single module is fixed, a fraction of a module may not be employed, thus fractions of a module so calculated may be rounded up or down to a whole number of modules as illustrated by Table 1. Rounding may be based on proximity to the closest whole number of modules, may be based upon the magnitude of modules, or may be based on another similar consideration. An example of rounding based on proximity to a closest whole number may be by rounding up if the calculation produces a fraction of 0.5 or greater, and rounding down if the fraction is less than 0.5. An example of rounding based on magnitude of modules may be rounding up if 20 or fewer modules will be included, and rounding down if greater than 20 modules will be included in intake section 315. Rounding based on the magnitude of modules may be employed to minimize cost and/or length of intake section 315.

Installing Modular Intake Section in Pump Assembly

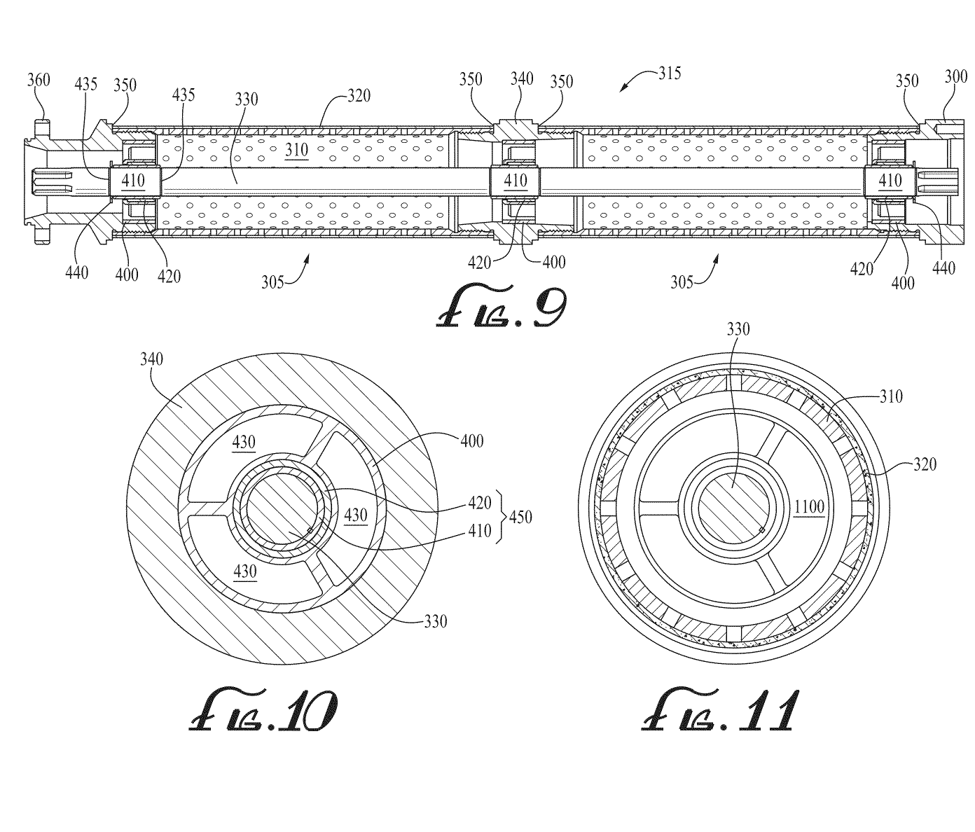

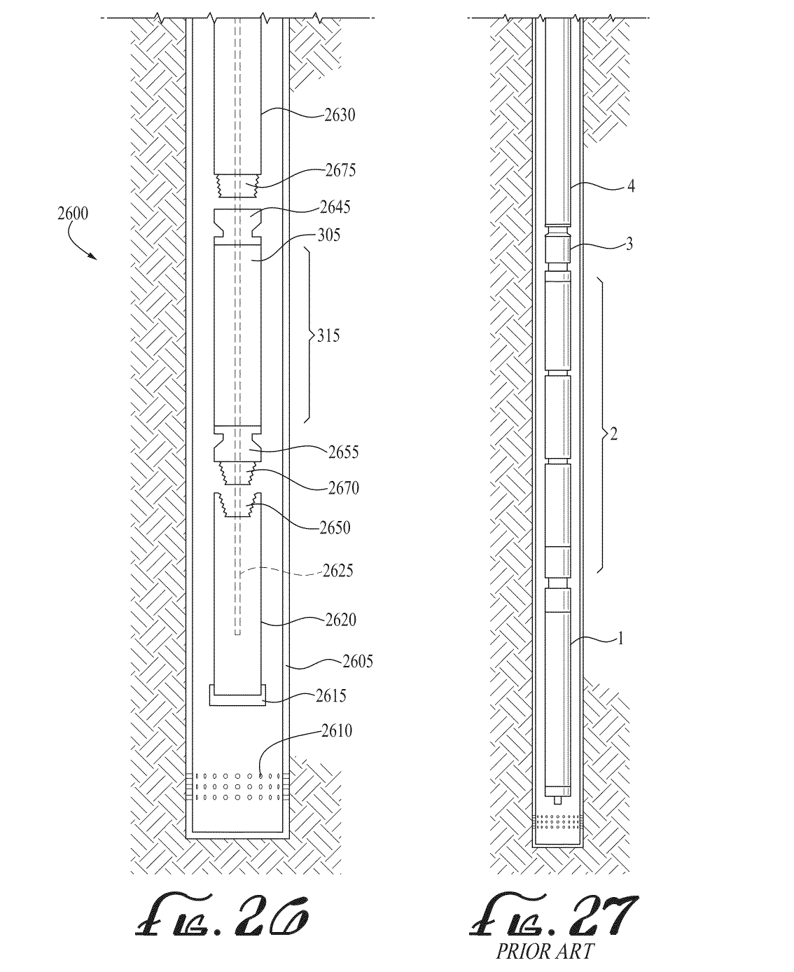

FIG. 25 is an illustrative embodiment of a method of installing a modular intake filter 305, for example, into an ESP assembly. At step 500, perforated housing 310 may be installed onto base 360. At step 510, slide O-ring 350 (shown in FIG. 9), over perforated housing 310 and press against the shoulder of base 360. O-ring 350 may be an o-ring set and/or made of synthetic rubber, a rubber composition and/or a fluoropolymer elastomer such as Viton (a registered trademark of E. I. Du Pont De Nemours & Company), or other material suitable for the environment. Next, slide porous media cartridge 320 over perforated housing 310 at step 520, followed by a second O-ring 350, which may be an O-ring set, braced on the shoulder of base 360 at step 530. In some embodiments, sealant may be used instead of, or in addition to, the O-rings 350. If another module 305 is needed in intake section 315 at step 540, for example as calculated above, guide 340 may be installed at step 550, perforated housing 310 may be installed on guide 340 at step 560, and steps 510 through 530 may be repeated bracing the O-rings 350 against guide 340 rather than against base 360. Steps 550, 560 and then steps 510 through 530 may be repeated until it is determined at step 540 that another module 305 is not needed.

If another module 305 is not needed, head 300 may be installed to complete the intake body at step 570. Sleeves 410 and retaining rings 435 may be installed onto shaft 330 at step 580. Shaft 330 may be installed into the intake body to complete intake section 315 at step 590. At step 595, the completed modular intake section 315 may be threaded and/or bolted to the components above and below intake section 315 in the pump assembly. In some embodiments, modules 305 of intake section 315 may be threaded to one another, and the modular intake section 315 may be bolted at head 300 to a pump, and bolted at base 360 to the seal section of the pump assembly. In such embodiments, a seal may be created in head 300 of the modular intake section 315 when the pump is installed, the pump holding the O-rings 350 on the pump, which seals against the inner diameter of the modular intake head 300.

O-rings 350 and/or sealant may be placed against the shoulder of perforated housing 310 in order to form a seal between the body of perforated housing 310 and porous media cartridge 320. If this seal is not made, solids may bypass porous media cartridge 320 at the shoulder. The first O-ring 350 may create a seal between porous media cartridge 320 and perforated housing 310 to prevent foreign solids from being ingested into the pump during operation. Second O-ring 350 attaches porous media cartridge 320 to perforated housing 310 in a replaceable and yet well-sealed fashion. In some embodiments, sealant may be used in place of, or in addition to, O-rings 350.

Modular Intake in Motion

When modular intake filter 305 is in motion, shaft 330 is turned from a base spline via the coupling to seal section 38 of the pump assembly. Sleeve 410 may be keyed to rotating shaft 330, thus rotating with shaft 330. Sleeve 410 rotates inside of stationary bushing 420, creating a radial support bearing during operation. Sleeve 410 and/or bushing 420 may be made of tungsten carbide or any other suitable material as detailed elsewhere herein or known to those of skill in the art. The radial support bearings may be affixed in the head 300, base 360 and/or guide 340 of intake section 315 and/or modular intake filter 305.

Radial support bearing set 450 may be held in place with retaining rings 435 (shown in FIG. 5) on shaft 330 above and below sleeve 410. Retaining rings 435 may be held in shaft 330 by a retaining ring groove. Shaft stop 440 (shown in FIG. 5) may be located at the ends of shaft 330, the shaft stop 440 contained within retaining rings 435 in addition to the outer sleeves 410. In some embodiments, only two shaft stops 440 may be used regardless of the number of modules 305 in an intake section 315, since they are installed near the ends (top and bottom sides) of shaft 330. Shaft stop 440 may prevent shaft 330 from sliding out of the assembly. For each head 300, base 360 and guide 340 there may be one radial support bearing set 450 having a bushing 420 and sleeve 410. In some embodiments, a single module will have two radial support bearings, one in head 300 and one in base 360. In some embodiments, a triple module with a head 300, two guides 340, and a base 360 would have four radial support bearings. Shaft 330 transmits rotation from the seal section 38 of the pump assembly to the pump 42 via a spline and coupling at the head 300.

FIG. 10 illustrates a cross section of a guide of one or more embodiments of the invention. Guide 340 may be threaded on both ends to allow connecting two perforated housings 310 to each other (top to bottom) using threads 1715 on perforated housing 310. Guide 340 may also enable the addition of spider bearing 400. Spider bearing 400 may house radial support bushing 420 and may remain stationary, while shaft 330 and sleeve 410 rotate. Multiple flow passages 430 around spider bearing 400 allow fluid flow to pass from module 305 to module 305 and eventually into the lower pump above head 300.

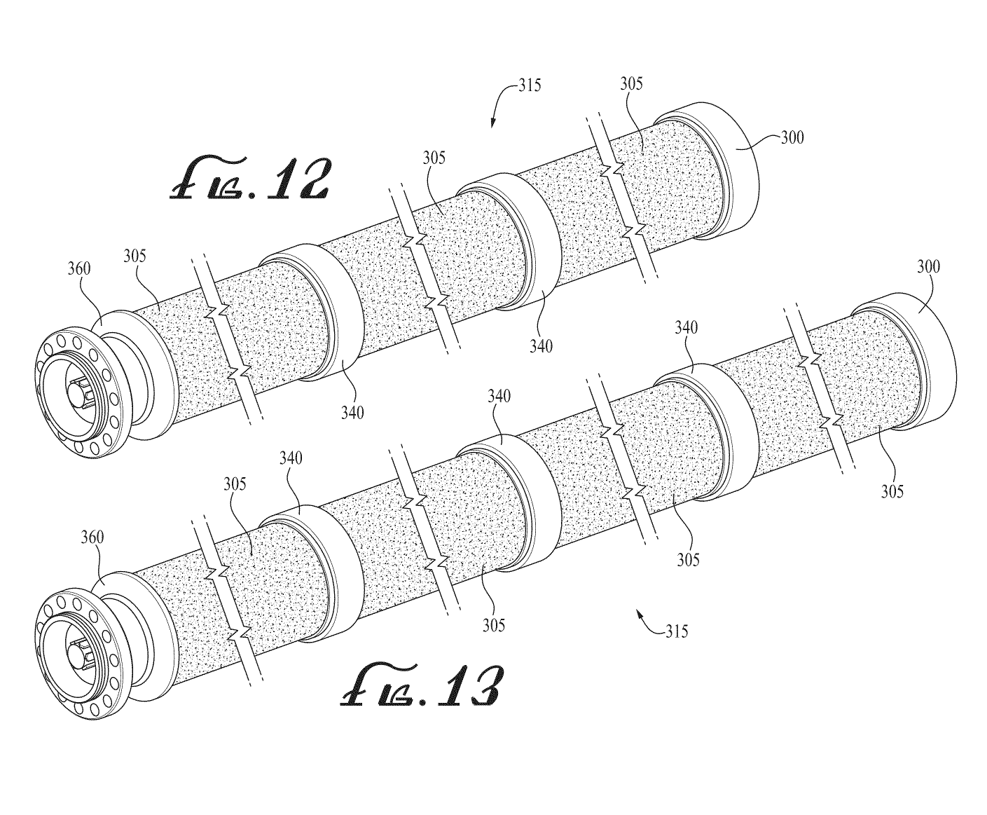

FIG. 11 illustrates a cross section of the modular intake filter apparatus of one or more embodiments of the invention midway down a modular intake filter 305. This figure illustrates that porous media cartridge 320 is circumferentially disposed about perforated housing 310. Between perforated housing 310 and shaft 330 is cylindrical opening 1100 allowing well fluid to flow to the pump.

Rod Pump Assembly

For ease of illustration and so as not to obscure the invention, the aforementioned description has been with respect to an ESP assembly embodiment. However, illustrative embodiments may be employed in other types of artificial lift assemblies, for example rod pump assemblies (also termed beam lift), hydraulic pumps, progressive cavity pumps or jet pumps. In such embodiments, modifications to intake section 315 may be required, particularly with head and base connections to adjacent pump assembly components. A rod pump assembly embodiment will now be described so as to illustrate the types of modifications which may be employed in order to implement illustrative embodiments in various types of artificial lift assemblies other than ESP assemblies.

FIG. 26 is an illustrative embodiment of a beam lift assembly making use of a modular intake filter of an illustrative embodiment. As shown in FIG. 26, beam lift assembly 2600 is located downhole in rod pump casing 2605. Well fluid enters casing 2605 through perforations 2610 which may be beneath beam lift assembly 2600. Bull plug 2615 may be at bottom end of gas separator 2620. Gas separator 2620 may assist in separating gas from pumped fluid prior to entry into rod pump 2630. Intake section 315, which includes one or more modular intake filters 305, may be secured between gas separator 2620 and rod pump 2630. Intake head box 2645 may be bolted onto modular intake filter 305 and connected to rod pump 2630 by head pin 2675, which may be a 2⅞ external upset end (EUE) pin and/or nipple. Intake base box 2655 may be bolted onto modular intake filter 305. Base box 2655 may be fitted with nipple 2670, which nipple 2670 may connect to base receiving box 2650, securing intake section 315 to gas separator 2620. This may allow intake section 315 to be placed below rod pump 2630 and above gas separator 2620. In some embodiments head box 2645, base box 2655 and/or base receiving box 2650 may be 2⅞ inch female EUE box connections, and head pin 2675 and/or base nipple 2670 may be EUE pin 2 2/78 male connections. Part measurements may vary based upon the size and type of pump assembly employed.

Concentric to the beam lift assembly 2600 may be a dip tube 2625 that extends longitudinally through rod pump 2630, intake section 315 and gas separator 2620. The assembly would allow for intake section 315 to serve as an intake while still allowing gas separator 2620 to provide gas free liquid to rod pump 2630.

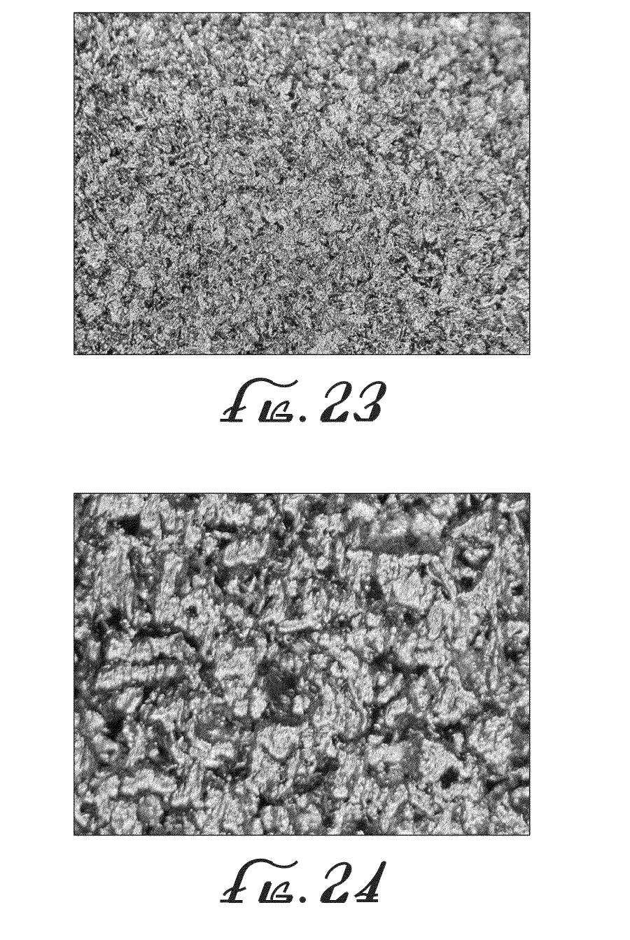

FIGS. 20-22 illustrate an intake section 315 for a rod pump assembly such as beam lift assembly 2600. As shown in FIGS. 20 and 22, modular intake filter 305 and guide 340 for a rod pump embodiment is as described above with respect to an ESP assembly embodiment. Rod intake head 2635 with head box 2645 may be configured to attach to rod pump 2630 with pin 2675. Rod intake base 2640 with base box 2655 are designed for attachment to gas separator 2620 with nipple 2670. Bolt-on discharge base box 2655 and/or head box 2645 may be a threaded and flanged sealed connecting device, converting tubing (pipe) threads to a bolted and sealed flange, thus allowing the modular intake 315 to integrate onto rod pump 2630 and/or gas separator 2620. FIG. 21 is a top view of an illustrative embodiment of an intake section 315 for a rod pump embodiment. Bolts 2100 are shown in FIGS. 21 and 22, which secure base box 2655 to base 2640 and head 2635 to head box 2645.

With respect to a rod pump embodiment, the determination of the number of modules needed in intake section 315 is similar to that of an ESP embodiment, taking into consideration differences such as the fixed surface area of a module, which may be different from that of an ESP embodiment, depending upon the dimensions of the pump for example, or any differences in what may be an acceptable flow rate or pressure drop based on the particular rod pump application.

Thus, the invention described here provides one or more embodiments of a modular intake filter system, apparatus and method. While the invention herein disclosed has been described by means of specific embodiments and applications thereof, numerous modifications and variations could be made thereto by those skilled in the art without departing from the scope of the invention set forth in the claims. The foregoing description is therefore considered in all respects to be illustrative and not restrictive. The scope of the invention is indicated by the appended claims, and all changes that come within the meaning and range of equivalents thereof are intended to be embraced therein.

What is claimed is:

1. An electric submersible pumping system comprising a modular intake filter for screening media from well fluid, the system comprising:
an electric submersible pump (“ESP”) assembly comprising:
an intake shaft that transfers horsepower from a seal section to a centrifugal pump of the ESP assembly; and
an intake section secured between the seal section and the centrifugal pump by a head on a downstream side and a base on an upstream side, the intake section comprising:
at least two modular intake filters comprising a perforated housing, each modular intake filter threadedly engaged to an adjacent modular intake filter by a guide; and
a porous media cartridge sealed to an exterior of the perforated housing, wherein a porosity of the porous media cartridge is selected to prevent media of a chosen size from entering the centrifugal pump.

2. The system of claim 1, wherein a number of the at least two modular intake filters is determined by:
calculating an area of filtration material required by dividing a selected flow rate of pumped fluid by a permeability of the porous media cartridge; and
calculating the number of the at least two modular intake filters by dividing the area of filtration material required by a surface area of a single modular intake filter.

3. The system of claim 1, wherein the intake section comprises a radial support bearing located in at least one of the head, the guide or the base.

4. The system of claim 3, wherein the radial support bearing comprises a rotatable sleeve keyed to the intake shaft and a stationary bushing pressed into the guide.

5. The system of claim 3, further comprising at least three radial support bearings, wherein one of the at least three radial support bearings is located in each of the head, guide and base.

6. The system of claim 1, further comprising a screen surrounding the exterior of the porous media cartridge.

7. The system of claim 1, wherein there are between two and forty modular intake filters.

8. The system of claim 1, wherein the porosity of the porous media cartridge is a media grade of between 0.1 and 100.

9. The system of claim 8, wherein the porous media cartridge is a sintered, porous metal.

10. A modular intake filter apparatus for an artificial lift pumping system, the modular intake filter apparatus comprising:
at least one modular intake filter comprising:
a perforated housing supportively engaged to a production pump of an artificial lift assembly; and
a porous media cartridge sealed to an exterior of the perforated housing, wherein a porosity of the porous media cartridge is selected to prevent media of a chosen size from entering the production pump; and
wherein a number of the at least one modular intake filter in the apparatus is determined by:
calculating an area of filtration material required by dividing a selected flow rate of pumped fluid by a permeability of the porous media cartridge; and
calculating the number of the at least one modular intake filters by dividing the area of filtration material required by a surface area of a single modular intake filter.

11. The apparatus of claim 10, wherein the perforated housing is threaded to the production pump by a head, wherein the head further comprises a spider bearing pressed into the head and a stationary bushing of a hydraulic bearing set pressedly coupled to the spider bearing.

12. The apparatus of claim 10, wherein the production pump is a rod pump.

13. The apparatus of claim 10, wherein the production pump is a multistage centrifugal pump.

14. The apparatus of claim 10, wherein there are between one and forty modular intake filters.

15. The apparatus of claim 10, wherein the porous media cartridge comprises porous metal.

16. The apparatus of claim 10, wherein the selected porosity of the porous media cartridge is a media grade of between 0.1 and 100.0.

17. The apparatus of claim 10, wherein a viscosity of the pumped fluid is about 1.0 centipoise and the selected flow rate is about 116.6 gallons per minute.

18. The apparatus of claim 10, further comprising a screen, the screen wrapped circumferentially about an outside of the porous media cartridge.

19. A method of filtering media from a fluid entering an artificial lift pump system, the method comprising:
selecting a porosity for a media cartridge to use in a modular intake filter for an artificial lift pumping application;
installing a media cartridge of the selected porosity on a perforated housing to form the modular intake filter; and
a step for computing a number of modular intake filters required to maintain a selected flow rate, the computation comprising at least the factors of:
a surface area of one of the modular intake filter;
the selected flow rate of pumped fluid; and
a permeability of the media cartridge of the selected porosity.

20. The method of claim 19, further comprising joining in series the required number of modular intake filters as computed.

21. The method of claim 20, wherein the required number of modular intake filters are joined by threading in series with a guide.

22. The method of claim 19, wherein installing the media cartridge on the perforated housing further comprises sealing the media cartridge onto the perforated housing.

23. The method of claim 19, wherein the step for computing the number of modular intake filters required further comprises rounding to a whole number of modules based on proximity to a nearest whole number of modules.

24. The method of claim 19, wherein the step for computing the number of modular intake filters required further comprises rounding to a whole number of modules based on a magnitude of modules.
